(19) United States
(12) Patent Application Publication
(10) Pub. No.: US 2021/0167853 A1
(43) Pub. Date: Jun. 3, 2021

(54) FREE SPACE OPTICS ON STATIONARY FIXTURES PRONE TO MOVEMENT

(71) Applicant: SIGNIFY HOLDING B.V., EINDHOVEN (NL)

(72) Inventors: MAURICE HERMAN JOHAN DRAAIJER, ITTERVOORT (NL); JAN EKKEL, OSS (NL); RUBEN RAJAGOPALAN, NEUSS (DE); HARRY BROERS, 'S-HERTOGENBOSCH (NL)

(73) Assignee: SIGNIFY HOLDING B.V., EINDHOVEN (NL)

(21) Appl. No.: 16/772,938

(22) PCT Filed: Dec. 4, 2018
(86) PCT No.: PCT/EP2018/083492

§ 371 Date: Jun. 15, 2020

(30) Foreign Application Priority Data
Dec. 15, 2017 (EP) 17207567.3

(51) Int. Cl. H04B 10/112; G01P 13/00

(52) U.S. Cl. CPC H04B 10/1123; H04B 10/1129; G01P 13/00

(57) ABSTRACT

Techniques disclosed herein relate to adjusting parameters that impact reliability of free space optics (“FSO”) between stationary fixtures. In various embodiments, a street lamp FSO system may include: motion sensor(s) (104, 204) to detect motion at location(s) of a street lamp (210); local FSO component(s) (108, 208) for deployment on the street lamp; and logic (102) to: receive first samples indicative of first motion of a first portion of the street lamp relative to abase (214) of the street lamp from the motion sensor(s); analyze the first samples to generate and store a reference motion profile for future use; receive second samples indicative of second motion of the street lamp from the motion sensor(s); compare the second samples with the reference motion profile; and based on the comparison, take action(s) to maintain a FSO communication beam between the local FSO component(s) and a remote FSO component.

### TECHNICAL FIELD

The present invention is directed generally to communications. More particularly, various methods and apparatus disclosed herein relate to techniques for adjusting various parameters that impact reliability of free space optics between stationary fixtures that are nevertheless prone to movement.

### BACKGROUND

The final leg(s) of telecommunication networks used to deliver telecommunication services to customers such as businesses or individuals are often referred to as the “last mile” or “last kilometer.” In many cases, the last mile comprises the biggest speed/throughput bottleneck in the entire telecommunications network. The last mile also tends to be the most expensive part of the telecommunications network to build and maintain because its hardware components are so numerous (e.g., separate components for individual residences) and are required to interface with a wide variety of user equipment. Radio frequency (“RF”) wireless technology can be used for last mile communications. However, Internet usage is experiencing exponential growth that is caused by factors such as increasing numbers of end users, increasing per-user bandwidth usage (e.g., streaming movies), increasing reliance on cloud services, and the growth of the Internet of Things (“IoT”). It is possible to reuse portion(s) of the RF spectrum, e.g., using small cells and beamforming, but this tends to be expensive. Consequently, RF wireless technology is no longer sufficient by itself for last mile telecommunications due to factors such as RF interference, etc. Additionally, it has always been challenging to deploy last mile wireless components (e.g., large 4G masts) in urban environments because people tend to resist such installations, for health and/or aesthetic reasons. Moreover, some urban environments are running out of easily-deployable locations.

Free Space Optics (“FSO”) is an optical communication technology in which light that is propagated through free space (e.g., air, vacuum, etc.) is modulated to enable wireless transmission of data. FSO shows promise for implementing last mile telecommunications, where it can be used to achieve, for instance, 10 Gbit per second upload and/or download speeds. In the future, higher speeds are expected. However, the optical communication beams employed by FSO are narrow and thus sensitive to relatively small movements. Relatively large structures such as buildings are suitable for mounting FSO communication components because they do not move a great deal. However, smaller stationary fixtures, particularly street lamps and other similar fixtures, tend to move and/or rotate in response to phenomenon such as wind, traffic, etc., and may move at rates that are influenced, for instance, by their mass, their shape, their size, the type of soil they are mounted in, etc. Consequently, mounting FSO components on such fixtures poses various challenges due to the narrowness of the FSO optical communication beams. While widening the optical beams may help, this also increases the likelihood that optical beams will interfere with each other, and also requires more power and may run afoul of eye safety standards.

### SUMMARY

The present disclosure is directed to inventive methods and apparatus for adjusting various parameters that impact reliability of free space optics between stationary fixtures that are nevertheless prone to movement. For example, in various embodiments, one or more motion sensors, such as one or more accelerometers, may be deployed at various locations of stationary fixtures such as street lamps. Samples collected from these motion sensors—which in some cases may be indicative of motion of a first portion of the stationary fixture (e.g., a position near its top) relative to a base of the stationary fixture—may be analyzed to determine movement profiles of the stationary fixtures. For example, (discrete and/or continuous) sample(s) may be collected from accelerometers deployed on a street lamp to determine how the street lamp tends to move in the presence of wind. The samples may be analyzed to generate a “motion profile” of the street lamp that provides a reference for later comparison. In many cases the motion profile may indicate that the street lamp tends to exhibit a state of mechanical resonance—i.e. the tendency of the street lamp to move or sway at greater amplitude when the frequency of its movements/swaying matches its natural frequency of vibration.

Once the motion profile for the stationary fixture is known, it can be used to determine when the stationary fixture is beginning to exhibit similar movement at a later time, e.g., by comparing new samples from the motion sensors to the reference motion profile. One or more remedial actions may then be taken to maintain a FSO communication beam between one or more local FSO components mounted on the stationary fixture and a remote FSO component mounted on a different structure in spite of the movement. These remedial actions may take various forms. In some embodiments, a controllable and movable weight may be deployed at the stationary fixture, e.g., packaged with a FSO component and/or one or more of the aforementioned motion sensors. This movable weight, which may take the form of a fixed wire or something similar, may be moved in a manner that tends to neutralize the newly detected movement, e.g., before the stationary fixture has a chance to build up to a heavy resonance/vibration.

Additionally or alternatively, in some embodiments one or more operational parameters of a local FSO component mounted to the stationary fixture may be altered. For example, the optical beam may be widened (subject to increased power usage), or communications over the optical beam may be exchanged during periodic intervals (e.g., during a moment of the periodic movement) in which the local FSO component is pointed directly at the remote FSO component. In some embodiments, if it is determined that communication between two FSO components will be too tenuous due to wind conditions, data that was intended to be routed through those FSO components may be rerouted to other FSO components, such as FSO components that are known to be less impacted by conditions or that are mounted to structures that are not (as) affected by conditions (e.g., massive buildings which do not move much in wind).

Generally, in one aspect, A street lamp free space optics (“FSO”) system may include: one or more motion sensors to detect motion at one or more locations of a street lamp; one or more local FSO components for deployment on the street lamp; and logic operably coupled with the one or more motion sensors and the one or more local FSO components. The logic may be configured to perform the following operations: receive a first plurality of samples from one or more of the motion sensors, wherein the first plurality of samples are indicative of first motion of a first portion of the street lamp relative to a base of the street lamp; analyze the first plurality of samples to generate a reference motion profile; store the reference motion profile for future use; receive a second plurality of samples from one or more of the motion sensors, wherein the second plurality of samples are indicative of second motion of the first portion of the street lamp relative to the base of the street lamp that occurs after the first motion; perform a comparison of the second plurality of samples with at least a portion of the reference motion profile; and based on the comparison, take one or more actions to maintain a FSO communication beam between one or more of the local FSO components and a remote FSO component.

In various embodiments, a movable weight may be positioned on the street lamp away from the street lamp base and is operably coupled with the logic, wherein the one or more actions include causing the movable weight to move. In various embodiments, causing the movable weight to move may include causing the movable weight to move in a manner that is selected to neutralize the second motion of the first portion of the street lamp relative to the base of the street lamp. In various embodiments, causing the movable weight to move comprises may cause the movable weight to move in a manner that is selected to synchronize motion of the street lamp with motion of a remote street lamp to which the remote FSO component is attached. In various embodiments, the movable weight may include a fixed piece of wire or a hanging weight.

In various embodiments, the logic may be further configured to: initiate movement of the movable weight to cause third motion of the first portion of the street lamp relative to the base of the street lamp; receive a third plurality of samples from one or more of the motion sensors, wherein the third plurality of samples are indicative of the third motion; analyze the third plurality of samples to generate a testing motion profile; perform a comparison of the testing motion profile with at least a portion of the reference motion profile; and based on the comparison, determine that an overall mass of the street lamp has been altered.

In various embodiments, the one or more actions may include one or more of widening the FSO beam and increasing an intensity of the FSO beam. In various embodiments, widening the FSO beam may include rotating an aspherical or asymmetrical lens.

In various embodiments, the remote FSO component may include an FSO receiver, the one or more local FSO components may include an FSO transmitter that generates the FSO communication beam, and the one or more actions may include causing the FSO transmitter to steer the FSO beam to an imaginary point at which link quality of the FSO communication beam satisfies a criterion while the street lamp reaches an outer spatial boundary of the reference motion profile. In various embodiments, the one or more actions may include repositioning one or more of the local FSO components to a different location on the street lamp.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization. Mass-produced telecom lasers may also be used in various embodiments described herein. These may emit light/electromagnetic radiation in various ranges, including but not limited to approximately 1300nm to 1500nm.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radio luminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

In various embodiments described herein, light sources such as LEDs and/or laser-based light sources may be modulated to carry information. For example, amplitude and/or polarization of emitted light may be modulated. In some cases, a continuous light source may be provided with an additional element that modulates the emitted light and/or rotates the polarization of the emitted light.

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

The terms “luminaire” and “lighting fixture” are used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The terms “logic” and “controller” are used herein generally to describe various apparatus relating to the operation of one or more light sources. A logic or controller can be implemented in numerous ways (e.g., such as with dedicated hardware) to perform various functions discussed herein. A “processor” is one example of a logic or a controller which employs one or more microprocessors that may be programmed using software (e.g., microcode) to perform various functions discussed herein. A logic or controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor, logic, or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g., for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 schematically illustrates a non-limiting example of components that may interact to implement techniques described herein.

FIG. 2 schematically illustrates a non-limiting example of how components may be deployed on a stationary fixture in the form of a street lamp, in accordance with various embodiments.

FIG. 3 depicts an example method for practicing selected aspects of the present disclosure, in accordance with various embodiments.

FIG. 4 depicts an example computing system architecture on which various aspects of the present disclosure may be implemented.

### DETAILED DESCRIPTION

The final leg(s) of telecommunication networks used to deliver telecommunication services to customers are often referred to as the “last mile” or “last kilometer.” Radio frequency (“RF”) wireless technology can be been used for last mile communications. However, as Internet usage continues to increase dramatically, RF wireless technology is no longer sufficient by itself for last mile telecommunications due to factors such as RF interference, etc. Free Space Optics (“FSO”) show promise for implementing last mile telecommunications. However, the optical communication beams employed by FSO are narrow and thus sensitive to relatively small movements. Relatively small stationary fixtures to which FSOs can readily be mounted, particularly street lamps and other similar fixtures, tend to move (e.g., rotate, vibrate due to traffic, sway) in response to phenomenon such as wind, traffic, etc.

In view of the foregoing, various embodiments and implementations of the present disclosure are directed to adjusting various parameters that impact reliability of free space optics between stationary fixtures that are nevertheless prone to movement. Examples will be described herein in which FSO components configured with selected aspects of the present disclosure are mounted to street lamps, which are ubiquitous in urban environments. However, this is not meant to be limiting. Any number of other stationary fixtures may be subject to movements that are similar to those experienced by street lamps, and hence, techniques described herein may be applied with those stationary fixtures as well. Other types of stationary fixtures for which FSO components described herein are suitable include street signs, flag poles, antennas (e.g., mounted on buildings), architectural structures (e.g., buildings that experience considerable movement, e.g., due to wind), structures to which traffic signals are mounted, bridges (e.g., towers of suspension bridges which are known to sway), and so forth. Stationary fixtures can be mounted on top of a horizontal surface (e.g., a street or sidewalk), on a vertical surface (e.g., the side of a building), on the bottom of a horizontal surface (e.g., underneath bridges and/or overpasses), or on any other surface of any orientation.

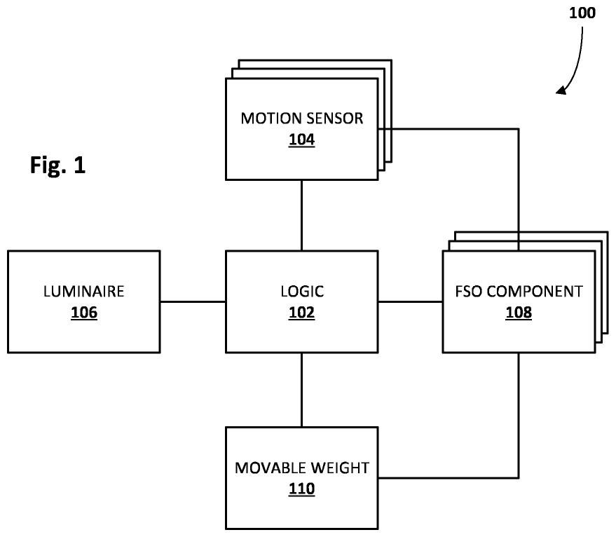

Referring to FIG. 1, in one embodiment, a stationary fixture (e.g., street lamp) FSO system 100 may include logic 102, one or more motion sensors 104, one or more luminaires 106, one or more FSO components 108, and/or one or more movable weights 110. As noted above, logic 102 may take various forms, such as a microprocessor that executes instructions stored in memory (not depicted in FIG. 1), an application-specific integrated circuit (“ASIC”), a field-programmable gate array (“FPGA”), and so forth. Logic 102 may be operably coupled with other components depicted in FIG. 1 using various communication technologies, such as one or more busses, wired networking technology (e.g., Ethernet), wireless networking technology (e.g., Bluetooth, Wi-Fi, mesh networks such as ZigBee or Z-Wave, etc.), or any combination thereof. And while not depicted in FIG. 1, in some embodiments, logic 102 may be operably coupled to one or more remote computing systems using one or more of the aforementioned networking technologies. In some embodiments, multiple FSO systems 100 may all be in network communication with one or more control computing systems (e.g., that form part of the so-called “cloud”) that may be configured to perform selected aspects of the present disclosure.

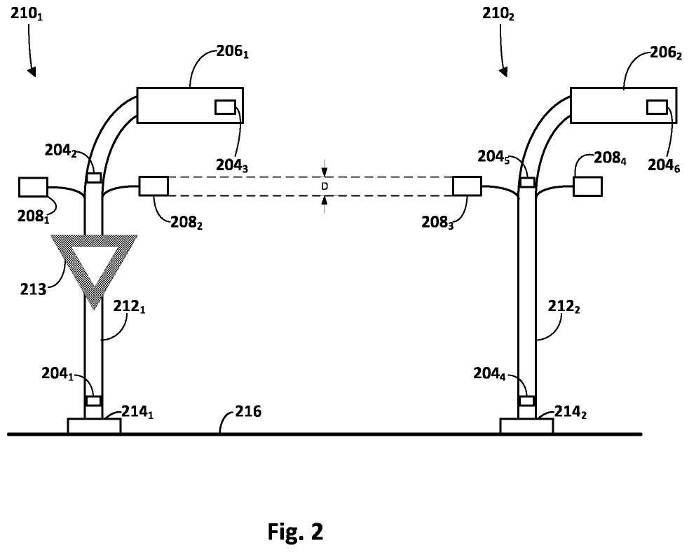

Motion sensor(s) 104 may come in various forms, and may be configured to detect various types of motion, such as lateral motion (e.g., swaying), rotation, up and/or down motion, change in orientation, etc. In some embodiments, one or more of motion sensors 104 may take the form of an accelerometer, such as a three-axis accelerometer. Additionally or alternatively, in various embodiments, one or more of motion sensors 104 may take the form of another type of motion sensor, such as a camera, a gyroscope, etc. In various embodiments in which multiple motion sensors 104 are employed, all the motion sensors 104 may be of the same type, or multiple different types of motion sensors may be employed. In various embodiments, one or more motion sensors 104 may be deployed at various locations of a stationary fixture. One example of how motion sensors 104 may be deployed at various positions of a street lamp is depicted in FIG. 2.

Additionally or alternatively, other types of sensors may be employed. When FSO components are separated by relatively short distances, translational movement of the underlying stationary fixtures may be dominant. However, with distances of, for instance, thirty meters, that are common between street lamps or other similar stationary fixtures, orientation of FSO components 108 may have a larger impact on FSO communications.

Accordingly, in some embodiments, other types of sensors may be employed that are usable to reconstruct the orientation of an optical axis of a FSO link. In some embodiments, these may include one or more microelectromechanical systems (“MEMS”) gyroscopes that are configured to measure angular velocity from which an orientation change can be derived. Additionally or alternatively, in some embodiments, multiple accelerometers may be employed to achieve the same result. Additionally or alternatively, in some embodiments, one or more optical sensors (e.g., cameras) may be employed to reconstruct, from one or more optical sensor frames, the optical sensor's pose (e.g., location and orientation). In embodiments in which three-dimensional (“3D”) cameras are employed, detecting a change in pose and/or orientation of the camera and/or the underlying stationary fixture via an observed 3D scene may be relatively simple. Additionally or alternatively, in some embodiments, time of flight of FSO communications may be used to detect variation in the distance between communicating FSO components. In case of a single distance measurement, the variation in distance may be indicative of a sway or swing of the underlying stationary fixture. In some embodiments, more spatial information may be used to obtain time of flight information, such as an eight-by-eight (or another dimension) time of flight sensor having, for instance, a similar optical view as FSO component 108. The 3D contour of the stationary fixture and/or FSO component 108 may be measured to reconstruct swaying or swinging behavior.

Luminaire 106 may take various forms, and as described above may include various types of light sources that are operably to illuminate an area. In embodiments where the stationary fixture on which system 100 is deployed is not a street lamp, luminaire 106 may be omitted. In various embodiments, other types of sensors may be deployed in order to corroborate or replace motion sensors. For example, in some embodiments, one or more optical sensors (not depicted) may be employed, in addition to or instead of motions sensors 104, to monitor light quality, orientation, and/or other attributes of an FSO optical beam between FSO components configured with selected aspects of the present disclosure. In some embodiments, this information may be used to estimate motion of the stationary fixture to which the optical sensors are mounted. For example, a light footprint cast by luminaire 106, e.g., onto the ground, may be monitored for location (e.g., relative to some reference indicia or point), quality, and/or shape to determine movement of a street lamp. In some embodiments, global position system (“GPS”) sensors that may in some cases be packaged with luminaire 106 may be used to, for example, synchronize FSO communication between a plurality of FSO components deployed on stationary fixtures across an area. In some embodiments, GPS sensors deployed on multiple stationary fixtures may be used to detect motion of the structures, e.g., by comparing GPS coordinates of the multiple structures over time.

FSO component(s) 108 may come in various form factors and may include one or both of a FSO transmitter and a FSO receiver. In cases where both a FSO transmitter and receiver are present in a single FSO component 108 (or more generally, where the FSO component 108 is capable of both transmitting and receiving), the FSO component 108 may be referred to as an “FSO transceiver.” In various implementations, FSO component(s) 108 may be configured to emit an optical beam towards another FSO component and/or receive an optical beam from another FSO component.

FSO components 108 may generate optical beams using various types of light technologies, such as lasers, LEDs, collimators, etc. Optical beams may be emitted as coherent and/or incoherent light, and may be emitted at various wavelengths of the electromagnetic spectrum, including visible and/or non-visible (e.g., infrared) light. In various implementations, optical beams emitted by FSO components 108 may be as narrow a few centimeters in diameter or less, and may be expanded to as large as thirty centimeters or more in diameter. Widening the optical beam may require more power and, at least in some jurisdictions, may run afoul of regulations pertaining to eye safety if done excessively.

Given the nature of optical beams, particularly their relatively narrow widths, it is important that two FSO components maintain direct line of sight with each other to communicate using FSO. Accordingly, techniques are described herein for detecting motion of stationary fixtures to which FSO components are mounted and learning motion profiles of those stationary fixtures. These learned motion profiles are referred to herein as “reference” motion profiles. Later, subsequently detected motion of those stationary fixtures may be compared to the reference motion profiles in order to take various remedial actions to maintain a FSO communication beam between one or more local FSO components secured to the stationary fixture and a remote FSO component (which also may be mounted to a remote stationary fixture for which movement is monitored using techniques described herein).

To this end, in some embodiments, system 100 may include one or more movable weights 110 that are movable, e.g., via one or more commands issued by logic 102, to move in a manner (e.g., counter-resonance) that is selected to neutralize motion of a first portion of a stationary fixture, such as a portion near the top of a street lamp, relative to the base of the stationary fixture. Movable weight 110 may come in various forms, such as a swinging wire, a hanging weight, a weight that is shaped so that it can be rotated in various directions to change a center of mass, etc.

Other remedial actions may also be performed, in addition to or instead of moving movable weight 110, to maintain a FSO communication beam between two or more FSO components mounted to different stationary fixtures. For example, suppose a local FSO component mounted to a stationary fixture under consideration includes an FSO transmitter that generates an FSO communication beam. Suppose further that the FSO communication beam is destined for a remote FSO component that includes an FSO receiver. In various implementations, logic 102 may cause the local FSO transmitter to steer the FSO beam to an imaginary point at which link quality of the FSO communication beam satisfies a criterion while the stationary fixture to which the local FSO transmitter is mounted reaches an outer spatial boundary of its reference motion profile. In various implementations, this criterion may be the FSO communication beam being at its strongest, or at least satisfying a strength/bandwidth threshold.

Additionally or alternatively, in some embodiments, logic 102 may cause a local FSO component 108 to widen its beam in response to detected movement of the underlying stationary fixture. Additionally or alternatively, in some embodiments, one or more FSO components may be operated to transmit and/or receive data during time intervals during which the one or more FSO components are calculated to be facing one or more remote FSO components. And, if FSO communication between two FSO components is deemed to be too difficult as a consequence of stationary fixture motion, in some embodiments, data intended to be routed through the affected FSO components may be rerouted, e.g., to less-affected FSO components and/or even to other means of telecommunication. Indeed, in various embodiments in which reference motion profiles are generated for large numbers of stationary fixtures, it can be determined at any point in time which stationary fixtures are moving (e.g., to an extent at which local remedial measures will not help) and which are not, and communications can be rerouted accordingly.

Reference motion profiles associated with stationary fixtures may change over time. For example, a street lamp may have signs or other objects mounted to it, taken away, etc. In some cases, objects such as signs may simply fall off or be stolen. Other objects that may be mounted to and/or taken off stationary fixtures include, but are not limited to, traffic signals, hanging plants, FSO components, hanging garbage bins, etc. When these objects are added or subtracted from the stationary fixtures, the masses of the stationary fixtures change and/or in some cases they may tilt/rotate slightly. Accordingly, techniques described herein can be used repeatedly over time to maintain up-to-date reference profiles associated with stationary fixtures.

In some embodiments, movement of stationary fixtures may be purposefully initiated to detect when objects have been added or taken away. For example, in some implementations, logic 102 may initiate movement of movable weight 110 to cause motion of a first portion of a street lamp, such as a portion near its top, relative to the base of the street lamp. In some embodiments, logic 102 may cause movable weight 110 to move in a manner that attempts to recreate a previously-observed resonance or movement of the street lamp, e.g., which may be indicated in its previously-created reference motion profile. This induced motion may result in logic 102 receiving a plurality of samples from one or more of the motion sensors 104 deployed on the street lamp. Logic 102 may then analyze the newly-received plurality of samples to generate what will be referred to herein as a “testing” motion profile. Logic 102 may perform a comparison of the testing motion profile with at least a portion of the reference motion profile previously created for the street lamp. Based on the comparison, logic 102 determine that an overall mass of the street lamp has been altered, which may indicate addition or subtraction of an object to the street lamp.

FIG. 2 depicts one non-limiting example of how one or more FSO optic systems (e.g., 100) may be deployed on a pair of street lamps, 2101 and 2102, in accordance with various embodiments. Street lamps 210₁-210₂ in FIG. 2 include respective luminaires 206₁-206₂, poles 212₁-212₂, and bases 214₁-214₂ that are affixed to a horizontal surface 216, which may be, for instance, a street, a sidewalk, the ground, a rooftop, etc. In other embodiments, stationary fixtures may be secured to non-horizontal surfaces, such as walls, architectural features, etc. In FIG. 2, first street lamp 210₁ includes a sign 213 that adds at least some mass to street lamp 210₁, and thus impacts its movement.

Street lamps 2101₁₋₂ of FIG. 2 are typical in that they extend upward from horizontal surface 216 and are free near their tops (or “distal ends”). Yet, street lamps 210₁₋₂ are not as massive as other vertically extending structures such as buildings, and therefore are subject to movements caused by forces such as wind, traffic, etc. Techniques described herein can be used to detect these movements and custom generate the aforementioned reference motion profiles for each street lamp. In some embodiments, vibration characteristics of a stationary fixture may be computed a priori, e.g., using Eigen frequencies, and used for various calculations described herein, although this is not required.

In various embodiments, the reference motion profiles for a plurality of stationary fixtures such as street lamps may be used for a variety of purposes. For example, suppose all street lamps in a metropolitan area are equipped with components configured with selected aspects of the present disclosure, and their respective motion profiles learned. Different street lamps and other stationary fixtures may exhibit different levels and/or types of movements, e.g., depending on whether they are exposed to wind corridors or sheltered from wind by buildings. In various embodiments, a map can be created that includes all street lamps in the metro area, and in some cases those street lamps may be localized on the map using GPS signals generated at each street lamp. This map, which could for instance be displayed as part of a graphical user interface of a computer system, can provide information about which street lamps exhibit relatively infrequent and/or minimal movement, and therefore are best-suited for mounting of FSO components. Additionally or alternatively, if the dimensions of the street lamps (or any other stationary fixtures) are known, in some embodiments, such a map (or more generally, motion profiles of the stationary fixtures) can be used to determine what height to mount FSO components at each street lamp. For example, a height for each street lamp may be determined at which vibration is minimum and yet the FSO components would be mounted high enough so that their optical beams are not blocked by other objects.

Referring back to FIG. 2, in this example, first street lamp 210₁ is equipped with three motion sensors 204₁₋₃ and second street lamp 210₂ is also equipped with three motion sensors 204₄₋₆. Of course, this is only an example; other numbers of motion sensors 204 may be deployed on each stationary fixture, and different numbers of motion sensors 204 can be deployed on different stationary fixtures. Moreover, different types of motion sensors may be deployed across different street lamps and even on an individual street lamp. In FIG. 2, motion sensors 204₁₋₆ may be accelerometers, but other types of motion sensors may be deployed. In this example, a motion sensor 204 near a top of a street lamp 210, such as third motion sensor 204₃, may experience more movement than, say, a motion sensor 204 near a base 214 of a street lamp 210, such as first motion sensor 204₁. Intermediate motion sensors 204 deployed near a middle of a stationary fixture, such as second motion sensor 204₂ and fifth motion sensor 204₅, may experience an intermediate level of motion.

First street lamp 210₁ is equipped with two FSO components, 208₁ and 208₂. Second street lamp 210₂ likewise is equipped with two FSO components, 208₃ and 208₄. Thus, as used herein, FSO components 208₁ and 208₂ may be considered “local” to first street lamp 210₁, whereas FSO components 208₃ and 208₄ may be considered “remote” to first street lamp 210₁. As noted above, FSO components 208₁₋₄ may each include an FSO transmitter, a FSO receiver, and/or both (in which case they may be referred to as a FSO “transceiver”). In this example, second FSO component 2082 is aimed at third FSO component 208₃. An FSO optical beam 218 between them (which may originate at FSO component 208₂ or FSO component 208₃) has a width (or diameter) of D.

If either street lamp 210₁ or 210₂ were to sway in any direction, a line of sight between FSO component 208₂ and FSO component 208₃ would be at least partially interrupted, which means the optical beam would at least partially miss its target. Accordingly, one or more of the remedial actions described above may be performed to either prevent street lamps 210 from moving (e.g., using movable weight 110) or to optimize the optical beam to compensate for the movement. In some embodiments, one or more FSO components 108/208 may be movably mounted on a stationary fixture, e.g., so that they can be moved (e.g., using a motor or magnets) as party of one or more of the aforementioned remedial actions.

Additionally or alternatively, in some embodiments, one or more movable/rotatable (e.g., aspherical) lenses may be positioned adjacent FSO components 108/208, and may be moved/rotated to widen/narrow/move an FSO optical beam 218. This may be beneficial, for instance, when there is still sufficient light intensity at the location of the receiving FSO component—the FSO beam may not need to be wider over the whole surface, but instead only a portion of the surface, because the FSO beam can be moved in a circular motion by rotating the lens.

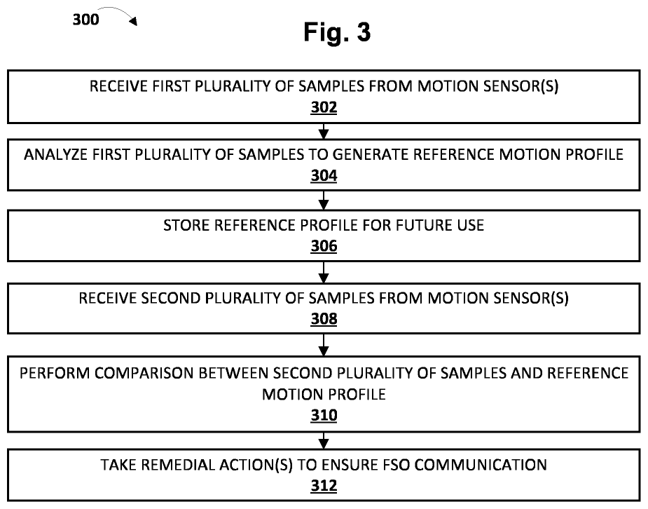

FIG. 3 depicts an example method 300 for performing selected aspects of the present disclosure. While particular operations of method 300 are depicted in a particular order, this is not meant to be limiting. Various operations may be added, omitted, or reordered.

At block 302, a first plurality of samples may be received, e.g., at logic 102 from one or more motion sensors (e.g., 104, 204) secured to one or more locations of a street lamp (e.g., 210, but could be any type of stationary fixture). In various embodiments, the first plurality of samples may be indicative of first motion of a first portion of the street lamp relative to a base of the street lamp. As noted above, this first motion may be caused, for instance, by wind, passing vehicles, large passing groups of pedestrians, nearby construction, and so forth.

At block 304, the first plurality of samples may be analyzed, e.g., by logic, to generate a reference motion profile. The reference motion profile may include a variety of information, such as a frequency of sway motion, how the swaying motion built up (e.g., how long it took to reach resonance of the street lamp), and so forth. In some embodiments, the reference motion profile may be annotated with information gathered from other sources, such as sensors that detect wind near the street lamp and/or light quality data from optical sensors. In some embodiments, these other sources may provide information that may be used, e.g., by logic 102, in conjunction with subsequent detected motion of the street lamp to perform one or more of the aforementioned remedial actions.

At block 306, the reference motion profile may be stored for future use. In some embodiments, reference motion profiles may be exchanged between FSO components, e.g., nearby or across an entire network (e.g., across a whole city). In some embodiments, matches and/or patterns may be found amongst multiple reference motion profiles that can be used to predict motion of stationary fixtures en masse and/or to plan accordingly. As should be evident, one particularly important purpose of reference motion profiles may be to correlate FSO communication quality with motion profiles.

At block 308, a second plurality of samples may be received from one or more of the motion sensors. The second plurality of samples may be indicative of second motion of the first portion of the street lamp relative to the base of the street lamp that occurs after the first motion. For example, the street lamp may be moved by wind, traffic, etc.

At block 310, a comparison may be performed of the second plurality of samples with at least a portion of the reference motion profile. For example, suppose the second plurality of samples was acquired over a ten-second period of time, beginning at the onset of the detected motion. In various embodiments, that ten seconds of samples may be compared to ten seconds of samples represented in the reference motion profile, e.g., the first ten seconds of the reference motion profile, to determine a similarity.

Based on the comparison, at block 312, one or more remedial actions may be taken to maintain a FSO communication beam between one or more local FSO components secured to the street lamp and a remote FSO component, e.g., secured to a remote stationary fixture such as another street lamp. Examples of these actions are described above, and include, for instance, moving movable weight 110 to neutralize and/or counteract the newly-detected motion, widening the optical beams, causing the transmitting FSO component to aim its emitted optical beam towards the aforementioned imaginary point, etc. In some embodiments, if may be determined, e.g., based on the comparison of block 310, that two stationary fixtures are moving such that their respect FSO components will face each other periodically for calculated time intervals. In various embodiments, the FSO components on one or both stationary fixtures may be operated to ensure that FSO communications are transmitted/received during these calculated time intervals.

In some embodiments, artificial intelligence such as deep learning may be employed to determine how to react to detected motion. For example, training data in the form of motion profiles labeled with desired responsive remedial actions may be used to train one or more machine learning models, such as one or more neural networks, etc. Errors between the output of the machine learning model and the labels may be used to train the machine learning model (e.g., using back propagation and/or stochastic gradient descent for neural networks) so that in the future, data indicative of detected motion (e.g., a feature vector representing the motion profile, a reduced dimensionality embedding, etc.) may be applied as input across the machine learning model to generate output that indicates, for instance, probabilities of various remedial actions being stochastically selected and performed.

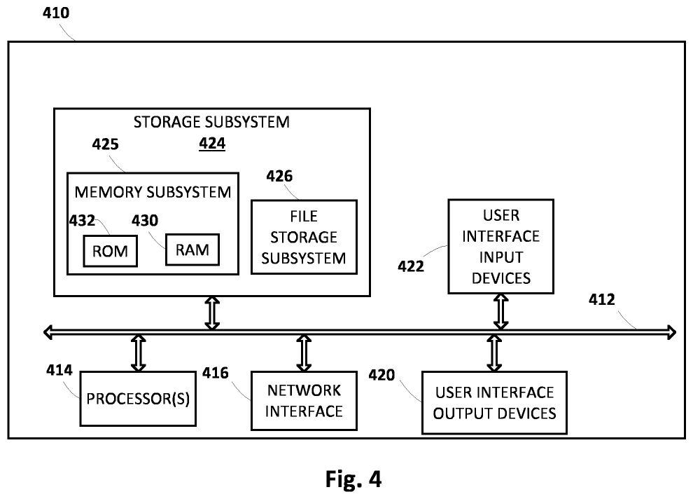

FIG. 4 is a block diagram of an example computing device 410 that may optionally be utilized to perform one or more aspects of techniques described herein. Computing device 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some or all of the modules described herein. For example, the storage subsystem 424 may include the logic to perform selected aspects of the method of FIG. 3, as well as to implement various components depicted in FIGS. 1-2.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem may use multiple busses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United

States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

1. A street lamp free space optics (“FSO”) system, comprising:
one or more motion sensors to detect motion at one or more locations of a street lamp;
one or more local FSO components for deployment on the street lamp; and
logic operably coupled with the one or more motion sensors and the one or more local FSO components, wherein the logic is configured to perform the following operations:
receive a first plurality of samples from one or more of the motion sensors, wherein the first plurality of samples are indicative of first motion of a first portion of the street lamp relative to a base of the street lamp;
analyze the first plurality of samples to generate a reference motion profile;
store the reference motion profile for future use;
receive a second plurality of samples from one or more of the motion sensors, wherein the second plurality of samples are indicative of second motion of the first portion of the street lamp relative to the base of the street lamp that occurs after the first motion;
perform a comparison of the second plurality of samples with at least a portion of the reference motion profile; and
based on the comparison, take one or more actions to maintain a FSO communication beam between one or more of the local FSO components and a remote FSO component.

2. The street lamp FSO system of claim 1, further comprising a movable weight that is positioned on the street lamp away from the street lamp base and is operably coupled with the logic, wherein the one or more actions include causing the movable weight to move.

3. The street lamp FSO system of claim 2, wherein causing the movable weight to move comprises causing the movable weight to move in a manner that is selected to neutralize the second motion of the first portion of the street lamp relative to the base of the street lamp.

4. The street lamp FSO system of claim 2, wherein causing the movable weight to move comprises causing the movable weight to move in a manner that is selected to synchronize motion of the street lamp with motion of a remote street lamp to which the remote FSO component is attached.

5. The street lamp FSO system of claim 1, wherein the one or more actions include one or more of widening the FSO beam and increasing an intensity of the FSO beam.

6. The street lamp FSO system of claim 1, wherein the remote FSO component includes an FSO receiver, the one or more local FSO components include an FSO transmitter that generates the FSO communication beam, and the one or more actions include causing the FSO transmitter to steer the FSO beam to an imaginary point at which link quality of the FSO communication beam satisfies a criterion while the street lamp reaches an outer spatial boundary of the reference motion profile.

7. The street lamp FSO system of claim 1, wherein the one or more actions include repositioning one or more of the local FSO components to a different location on the street lamp.

8. A method comprising:
receiving, from one or more motion sensors secured to one or more locations of a street lamp, a first plurality of samples, wherein the first plurality of samples are indicative of first motion of a first portion of the street lamp relative to a base of the street lamp;
analyzing the first plurality of samples to generate a reference motion profile;
storing the reference motion profile for future use;
receiving, from one or more of the motion sensors, a second plurality of samples, wherein the second plurality of samples are indicative of second motion of the first portion of the street lamp relative to the base of the street lamp that occurs after the first motion;
perform a comparison of the second plurality of samples with at least a portion of the reference motion profile; and
based on the comparison, take one or more actions to maintain a FSO communication beam between one or more local FSO components secured to the street lamp and a remote FSO component.

9. The method of claim 8, further comprising causing a movable weight to move, wherein the movable weight is positioned on the street lamp away from the street lamp base.

10. The method of claim 9, wherein causing the movable weight to move comprises causing the movable weight to move in a manner that is selected to synchronize motion of the street lamp with motion of a remote street lamp to which the remote FSO component is attached.

11. The method of claim 8, wherein the one or more actions include one or more of widening the FSO beam using an aspherical or asymmetrical lens and increasing an intensity of the FSO beam.

12. At least one non-transitory computer-readable medium comprising instructions that, in response to execution of the instructions by one or more processors, cause the one or more processors to perform the method of claim 8.

13. A free space optics (“FSO”) system, comprising:
one or more accelerometers-444 to detect motion at one or more locations of a stationary fixture;
one or more local FSO components for deployment on the stationary fixture; and
one or more processors operably coupled with the one or more accelerometers and the one or more local FSO components, wherein the one or more processors are configured to execute instructions stored in memory to implement the following operations:
receive a first plurality of samples from one or more of the accelerometers, wherein the first plurality of samples are indicative of first motion of a first portion of the stationary fixture relative to a base of the stationary fixture;
analyze the first plurality of samples to generate a reference motion profile;
store the reference motion profile for future use;
receive a second plurality of samples from one or more of the accelerometers, wherein the second plurality of samples are indicative of second motion of the first portion of the stationary fixture relative to the base of the stationary fixture that occurs after the first motion;
perform a comparison of the second plurality of samples with at least a portion of the reference motion profile; and
based on the comparison, take one or more actions to optimize FSO communication between one or more of the local FSO components and a remote FSO component mounted to a remote stationary fixture.

14. The FSO system of claim 13, further comprising a movable weight that is positioned on the stationary fixture away from the stationary fixture base and is operably coupled with one or more of the processors, wherein the one or more actions include causing the movable weight to move in a manner that is selected to neutralize the second motion of the first portion of the stationary fixture relative to the base of the stationary fixture.

15. The FSO system of claim 13, wherein the one or more actions include causing the one or more local FSO components to transmit or receive data during time intervals during which the one or more local FSO components and the remote FSO component are calculated to be facing each other.
